(19) United States
(12) Patent Application Publication
(10) Pub. No.: US 2026/0298650 A1
(43) Pub. Date: Oct. 1, 2026

(54) SYSTEMS AND METHODS FOR 3D PLOT VISUALIZATION

(71) Applicant: AVRIDE Inc., Newburyport, MA (US)

(72) Inventors: Lev Simonov, Tel Aviv (IL); Roman Udovichenko, Austin, TX (US)

(21) Appl. No.: 19/578,598

(22) Filed: Mar. 25, 2026

Related U.S. Application Data
(60) Provisional application No. 63/777,168, filed on Mar. 25, 2025.

(51) Int. Cl. G01C 21/36; G06T 17/00

(52) U.S. Cl. CPC G01C 21/3638; G06T 17/00

(57) ABSTRACT

Provided herein is a system and method for three-dimensional plot visualization, the system including: at least one processor; and a memory communicatively connected to the at least one processor, wherein the memory contains instructions configuring the at least one processor to: receive a spatial trajectory for an autonomous vehicle; receive a speed profile for the autonomous vehicle; generate a three dimensional visualization, wherein generating the three dimensional visualization includes: placing the spatial trajectory within a three-dimensional rendered space; generating a primary plot, wherein generating the primary plot includes: defining a spatial axis along an arc length along the spatial trajectory; defining a temporal axis as a vertical axis; and plotting the speed profile for the autonomous vehicle on the spatial axis and the temporal axis; and displaying the three dimensional visualization to a user through a display device.

### CROSS REFERENCE TO RELATED APPLICATIONS

This application claims the benefit of priority to U.S. Provisional Application No. 63/777,168, filed on Mar. 25, 2025, and entitled “3D PLOT VISUALIZATION SYSTEM FOR SELF-DRIVING VEHICLE MOTION PLANNING,” the entirety of which is incorporated herein by reference.

### FIELD OF THE INVENTION

The present invention is directed generally to data visualization methods and systems. Particularly, the present invention is directed to systems and methods for 3D plot visualization.

### BACKGROUND OF THE INVENTION

Visualization for autonomous vehicle data is challenging because it comprises data that is tied to a three-dimensional speed. For example, a vehicle's speed is inherently related to the path that the vehicle takes through the world. The present invention provides an enhanced visualization system that significantly improves situational awareness and the ability to analyze agent interactions in context. Those and other advantages and benefits of the present invention will become apparent from the detailed description of the invention hereinbelow.

### SUMMARY

In some aspects, the techniques described herein relate to a system for three-dimensional plot visualization, the system including: at least one processor; and a memory communicatively connected to the at least one processor, wherein the memory contains instructions configuring the at least one processor to: receive a spatial trajectory for an autonomous vehicle; receive a speed profile for the autonomous vehicle; generate a three dimensional visualization, wherein generating the three dimensional visualization includes: placing the spatial trajectory within a three-dimensional rendered space; generating a primary plot, wherein generating the primary plot includes: defining a spatial axis along an arc length along the spatial trajectory; defining a temporal axis as a vertical axis; and plotting the speed profile for the autonomous vehicle on the spatial axis and the temporal axis; and displaying the three dimensional visualization to a user through a display device.

In some aspects, the techniques described herein relate to a method for three-dimensional plot visualization, the method including: receiving, using at least one processor, a spatial trajectory for an autonomous vehicle; receiving, using the at least one processor, a speed profile for the autonomous vehicle; generating, using the at least one processor, a three dimensional visualization, wherein generating the three dimensional visualization includes: placing the spatial trajectory within a three-dimensional rendered space; generating a primary plot, wherein generating the primary plot includes: defining a spatial axis along an arc length along the spatial trajectory; defining a temporal axis as a vertical axis; and plotting the speed profile for the autonomous vehicle on the spatial axis and the temporal axis; and displaying, using the at least one processor, the three dimensional visualization to a user through a display device.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of a system for three-dimensional plot visualization;

FIG. 2 shows an exemplary 3D visualization;

FIG. 3 shows another exemplary 3D visualization;

FIG. 4 shows an exemplary multi-trajectory 3D visualization;

FIGS. 5A and 5B show an exemplary vehicle computing architecture;

FIG. 6 shows an exemplary method for three-dimensional plot visualization; and

FIG. 7 shows a diagrammatic representation of one embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

A “vehicle,” for the purposes of this disclosure is a device that is designed to transport goods, people, and/or animals.

For the purposes of this disclosure, an “autonomous vehicle” is a device that is capable of moving people or things from one point to another in a manner that relies primarily on computer algorithms to guide and control the vehicle.

For the purposes of this disclosure, a “spatial trajectory” is a path or planned path through space for an autonomous vehicle.

A “3D visualization,” for the purposes of this disclosure, is a presentation of data, wherein the data is rendered using three dimensions in a three-dimensional space.

A “spatio-temporal (ST) graph,” for the purposes of this disclosure, is a data representation matching spatial movement and evolution over time.

### Detailed Description

The present disclosure is directed to an enhanced visualization system for self-driving vehicle motion planning. It may include, as a non-limiting example, integration of spatio-temporal (ST) graphs directly into three-dimensional scene representation. The present disclosure may also include a method of projecting interaction zones with other agents directly above the planned trajectory in the 3D environment. For example, this may be done using shading on one or more of the plots as described through out the disclosure. Furthermore, the present disclosure includes, in some embodiments, locating the spatio-temporal graph data over the corresponding segments of the vehicle's trajectory for improved visualization and understanding.

The present disclosure relates, in embodiments, to autonomous vehicles and their operation in various environments. The present disclosure further relates to, in embodiments, an enhanced visualization system for self-driving vehicle motion planning that integrates spatio-temporal (ST) graphs directly into three-dimensional scene representation. The integration between the potential interaction points and their physical locations in space offers an improvement over the prior art as it allows motion planning developers to precisely identify which parts of the planned trajectory correspond to specific areas on the spatio-temporal graph. In certain aspects, this integration significantly improves situational awareness and the ability to analyze agent interactions in context. This disclosure further enhances decision-making for autonomous vehicle development by providing a unified visual representation that combines temporal and spatial data in a single, coherent 3D visualization rather than requiring developers to mentally map between separate 2D representations.

A 3D ST-graph may include a visualization and debugging construct used to represent, analyze, and interpret an autonomous vehicle's longitudinal (speed) planning decisions along a predefined spatial trajectory over time. It may extend the classical 2D space-time (s-t) graph into a three-dimensional, geometry-aware representation, allowing the planner's decisions to be inspected in the context of real road geometry, including curves, intersections, and interactions with dynamic obstacles. One exemplary purpose of the 3D ST-graph may be debugging, interpretability, and validation of autonomous vehicle speed planning. Specifically, it may enable engineers to, as non-limiting examples, understand why the vehicle slowed down, stopped, or accelerated, correlate speed decisions with specific obstacles, rules, or constraints, visually inspect conflicting constraints (e.g., pedestrian vs. vehicle vs. traffic lights), and/or diagnose planner conservatism, infeasibility, or oscillations. This tool may, in embodiments, not be required for runtime control, but it is particularly beneficial for offline analysis, simulation review, and development.

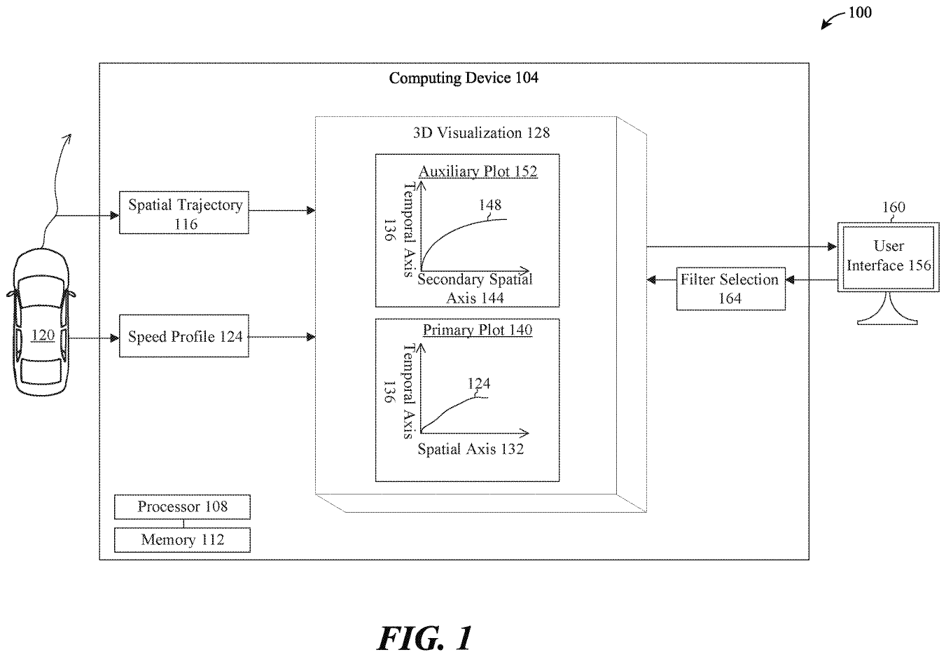

Referring now to FIG. 1, an exemplary embodiment of system 100 for three-dimensional plot visualization is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may include at least one processor 108. Computing device 104 may include a memory 112 communicatively connected to the at least one processor 108. Memory 112 may include one or more instructions configuring at least one processor 108 to perform one or more actions or steps as described throughout this disclosure.

With continued reference to FIG. 1, memory 112 may include instructions configuring processor 108 to receive a spatial trajectory 116 for an autonomous vehicle 120. In some embodiments, vehicle 120 may be motorized. As non-limiting examples, vehicle 120 may include a car, a scooter, a bike, an ATV, a motorcycle, a motorbike, a minibike, a truck, a golf cart, an aircraft, and the like. In some embodiments, vehicle 120 may be human powered. As non-limiting examples, vehicle 120 may include a bike, a rickshaw, a skateboard, a scooter, or the like.

With continued reference to FIG. 1, spatial trajectory 116 may include one or more points that vehicle 120 may transit through or may be planning to transit through. In some embodiments, spatial trajectory 116 may include a spline. Spline may be define piecewise using polynomials. In some embodiments, spatial trajectory 116 may be defined using a plurality of polynomial functions. In some embodiments, spatial trajectory 116 may be defined using a cubic function. In some embodiments, spatial trajectory 116 may be defined using a quadratic function. In some embodiments, spatial trajectory 116 may include a plurality of points (e.g., x-y coordinates, or x-y-z coordinates). Plurality of points may be, as non-limiting examples, relative to vehicle 120 or to a global coordinate system. In some embodiments, computing device 104 may be configured to perform a curve fit on the plurality of points to generate a smooth curve, which could be used for other steps in this disclosure. Curve fit may include, as non-limiting examples, a least squares fit, non-linear least squared fit, a regression fit, a Levenberg-Marquardt algorithm, or the like.

With continued reference to FIG. 1, spatial trajectory 116 may include a path for vehicle 120 to take. For example, spatial trajectory 116 may include, as non-limiting examples, a turn, moving through an intersection, changing lanes, passing another vehicle, avoiding another vehicle, following a lane or road, parking, stopping, and the like.

With continued reference to FIG. 1, memory 112 may include instructions configuring processor 108 to receive a speed profile 124. Speed profile 124 may include a profile for the speed of vehicle 120. For example, speed profile 124 may include a plurality of datapoints relating to a vehicle 120's speed over time. Speed profile 124 may be a planned speed profile. Speed profile 124 may be a calculated speed profile-as a non-limiting example, a calculated speed profile from an autonomous driving algorithm.

With continued reference to FIG. 1, memory 112 may include instructions configuring processor 108 to receive one or more auxiliary parameters related to vehicle 120. As non-limiting examples, auxiliary parameters may include vehicle speed, longitudinal acceleration, lateral acceleration, total acceleration, jerk, or path curvature. Auxiliary parameters may include data regarding one or more vehicles in the vicinity of vehicle 120. This may include, as non-limiting examples, speed, acceleration, or trajectory for other vehicles in the vicinity. Auxiliary parameters may include one or more constraints on vehicle 120. Constraints may include, as non-limiting examples, speed limits, construction zones, parked cars, red lights, stop signs, school zones, no passing zones, and the like.

With continued reference to FIG. 1, in some embodiments, memory 112 may include instructions configuring processor 108 to retrieve spatial trajectory 116, speed profile 124, and auxiliary parameters or other data relating to vehicle 120 from an autonomous vehicle database. Autonomous vehicle database may be implemented, without limitation, as a relational database, a key-value retrieval database such as a NOSQL database, or any other format or structure for use as a database that a person skilled in the art would recognize as suitable upon review of the entirety of this disclosure. Autonomous vehicle database may alternatively or additionally be implemented using a distributed data storage protocol and/or data structure, such as a distributed hash table or the like. Autonomous vehicle database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, memory 112 may include instructions configuring processor 108 to retrieve spatial trajectory 116, speed profile 124, and auxiliary parameters or other data relating to vehicle 120 from vehicle 120. In some embodiments, data from vehicle 120 may be received using a wireless connection. Wireless connection may include, as non-limiting examples, cellular communication, WiFi, 3G, 4G, EDGE, 2G, 5G, radio, line-of-sight, or the like. In some embodiments, data may be stored locally on vehicle 120 and communicated to computing device 104 at a later time. Later time may include, as a non-limiting example, when an appropriate wireless or wired connection is made. In some embodiments, data from vehicle 120 may be received using a wired connection. Wired connection may include, as non-limiting examples, ethernet, fiber, coax, USB, or the like.

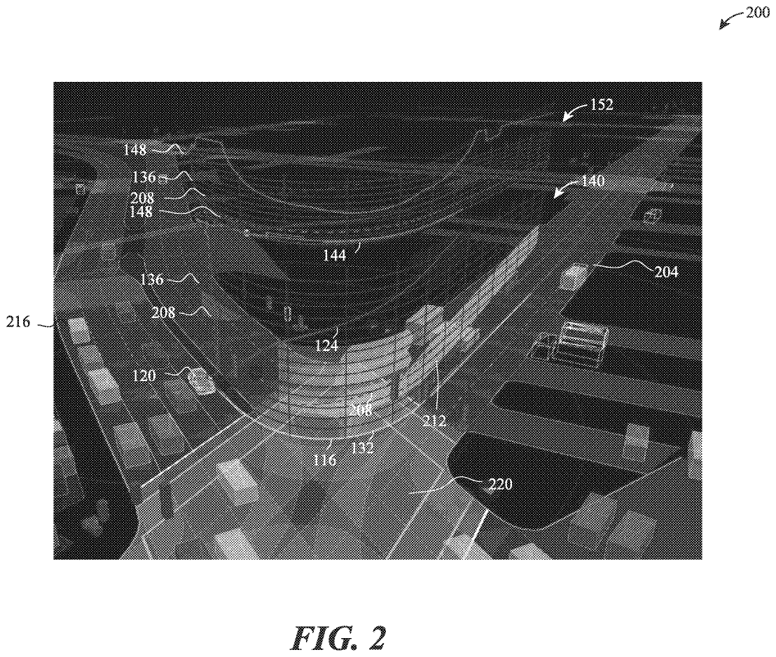

With continued reference to FIG. 1, memory 112 may include instructions configuring processor 108 to generate a three-dimensional (3D) visualization 128. In some embodiments, generating 3D visualization 128 may include placing spatial trajectory 116 within a 3D rendered space. 3D rendered space may include a representation of the world. As non-limiting examples, this map includes maps, roads, other vehicles, traffic lights, lanes, intersections, side walks, bike lanes, parking zones, and the like. Embodiments of visualization 128 are further are further described with reference to FIGS. 2-4.

With continued reference to FIG. 1, generating 3D visualization 128, may include defining a spatial axis 132. Spatial axis 132 may be defined along an arc length along spatial trajectory 116. In some embodiments, spatial axis 132 may be configured to follow one or more curvatures of spatial trajectory 116. As a non-limiting example, spatial axis 132 may be aligned to, e.g. a spatial trajectory 116 turning through an intersection. As such, spatial axis 132 may be aligned to a curve, such that the axis 132 may not be a straight line. In some embodiments, spatial trajectory 116 may be aligned the vehicle's front bumper or its base (middle of the rear axle).

With continued reference to FIG. 1, generating 3D visualization 128, may include defining a temporal axis 136 as a vertical axis. Vertical axis may be aligned for example, so as to be perpendicular to a horizon, wherein the horizon is relative to the 3D visualization 128. Temporal axis 136 may include a time dimension. For example, moving up temporal axis 136 may equate to increasing temporal displacement from a starting point.

With continued reference to FIG. 1, memory 112 may include instructions configuring processor 108 to generate a primary plot 140. Generating a primary plot 140 may include plotting the speed profile 124 for the autonomous vehicle on the spatial axis 132 and the temporal axis 136. In this matter, primary plot 140 may be aligned over spatial trajectory 116 within 3D visualization 128 due to the alignment of spatial axis 132 with spatial trajectory 116. This may allow for primary plot 140 to be presented in the context of 3D visualization 128 therapy allowing users to appreciate the context of primary plot 140 and elements of primary plot 140 within 3D visualization 128 including any other vehicles, restrictions, obstacles, or the like.

With continued reference to FIG. 1, memory 112 may include instructions configuring processor 108 to define a secondary spatial axis 144 along the arc length along the spatial trajectory 116. In some embodiments, secondary spatial axis 144 may include the same units as spatial axis 132. In some embodiments, secondary spatial axis 144 may include different units from spatial axis 132.

With continued reference to FIG. 1, auxiliary parameter 148 may be selected from the list consisting of vehicle speed, longitudinal acceleration, jerk, path curvature, speed limits, lateral acceleration, steering wheel angle, and steering wheel rotation rate. In some embodiments, auxiliary parameter 148 may include one or more of vehicle speed, longitudinal acceleration, jerk, path curvature, speed limits, and acceleration. Auxiliary parameter 148 may include any auxiliary parameter 148 as described throughout this disclosure.

With continued reference to FIG. 1, memory 112 may include instructions configuring processor 108 to generate an auxiliary plot 152. Generating auxiliary plot 152 may include plotting at least one auxiliary parameter 148 on secondary spatial axis 144 and temporal axis 136. Auxiliary plot 152 may be an additional plot to primary plot 140 where auxiliary plot 152 may show an auxiliary parameter 148. In some embodiments, selection of auxiliary parameter 148 may include receiving a user selection of an auxiliary parameter 148 through a user interface 156.

Referring now to FIG. 2, an exemplary 3D visualization 200 is shown. 3D visualization 200 includes a spatial trajectory 116. Spatial trajectory 116 of vehicle 120 may be displayed on a visual representation of the world. For example, spatial trajectory 116 may be displayed on a virtual representation of a road 204. Spatial trajectory 116 may be shown as a line on the ground. In some embodiments, spatial trajectory 116 may be a planned trajectory. For example, spatial trajectory 116 may be generated from an autonomous driving algorithm.

With continued reference to FIG. 2, primary plot 140 may include a temporal axis 136 and spatial axis 132. Spatial axis 132 may be defined as arc length along a specific, planned spatial trajectory 116. This may include, as non-limiting examples, a centerline or candidate path. The spatial axis 132 may follow the actual geometric curvature of the road 204. As a non-limiting example, this may be the actual geometric curvature of the road 204, not a straightened projection. In an embodiment, this may allow, as a result, the “surface” of the graph to bend and twist to match road turns, merges, and intersections.

With continued reference to FIG. 2, temporal axis 136 may be represented as a vertical axis. Temporal axis 136 value may increase as it moves upward. In some embodiments, a horizontal slice of primary plot 140 (i.e., primary plot 140 at a certain point on temporal axis 136) may correspond to a world state at a particular future time.

With continued reference to FIG. 2, primary plot 140 includes a speed profile 124. Speed profile 124 may include a planned speed profile for a vehicle 120. Speed profile 124 may be represented as a curve s(t). Equivalently, and in some embodiments, speed profile 124 may be represented as a curve t(s). Speed profile 124 may show the final trajectory that has been selected by the planner (e.g., a user).

With continued reference to FIG. 2, primary plot 140 may include one or more feasibility bounds 208. Feasibility bounds 208 may include one or more limits on the performance or operation of vehicle 120. One or more feasibility bounds 208 may include a maximum acceleration profile. One or more feasibility bounds 208 may include a maximum comfortable breaking profile. One or more feasibility bounds 208 may include an emergency breaking envelope. In some embodiments, emergency breaking envelope may include a more permissive breaking profile than maximum comfortable breaking profile, where emergency breaking profile may include breaking maneuvers that are uncomfortable, but safe, for occupants. One or more feasibility bounds 208 may include a reachable region in the s(t) space. Reachable region may include areas of primary plot 140 that it possible for vehicle 120 to reach. 3D visualization 128 may include a safe region in s(t) space. In some embodiments, one or more feasibility bounds 208 may include a dashed line. In some embodiments, one or more feasibility bounds 208 may include a dashes line showing the search domain for speed of vehicle 120.

With continued reference to FIG. 2, primary plot 140 may show one or more constraints 212. One or more constraints 212 may include one or more points where the planned profile becomes tangent to or constrained by obstacles, speed limits, comfort bounds, and/or legal rules. Constraints 212 may be shown using, as a non-limiting example, shading on primary plot 140.

With continued reference to FIG. 2, one or more feasibility bounds 208 and one or more constraints 212 may allow users, such as engineers, to see if the planning software is physically constrained, rule constrained, or being overly conservative. This allows for better diagnosis of issues related to route and parameter planning for autonomous vehicles. This is further improved by the alignment of spatial axis 132 with spatial trajectory 116 which situates this information in a 3D visualization 200 which makes all of this information more easily digestible by a user.

With continued reference to FIG. 2, primary plot 140 may include breaking distances. These may be shown using, as a non-limiting example, one or more feasibility bounds 208 as described further above. In some embodiments, some one or more feasibility bounds 208 may be stop lines, wherein the one or more feasibility bounds 208 represent lines that should not be crossed by the planning algorithms. Braking profiles may include normally acceptable braking profiles or emergency braking profiles. Speed profile 124 may be represented in a solid line.

With continued reference to FIG. 2, primary plot 140 and auxiliary plot 152 may be rendered within the same 3D world frame and map, rather than as an abstract 2D plot. This allows for greater spatial correspondence between, as non-limiting examples, road lanes, vehicle 120 pose, obstacles, and space-time constraints. This offers a clear improvement over the prior by allowing for easier diagnosis of decisions made by the autonomous vehicle.

With continued reference to FIG. 2, in some embodiments, auxiliary plot 152 may be located above primary plot 140. In some embodiments, auxiliary plot 152 may be located alongside primary plot 140. Auxiliary plot 152 may include an auxiliary parameter auxiliary parameter 148. Auxiliary parameter may include, as non-limiting examples, vehicle 120 speed, longitudinal acceleration, lateral acceleration, jerk, path curvature, speed limits, speed limits sources (e. g, map, signage, construction, dynamic rule), and/or constraint activation flags.

With continued reference to FIG. 2, auxiliary plot 152 may further enable better causal reasoning for users. As a non-limiting example, auxiliary plot 152 (in conjunction with the other elements of 3D visualization 200) may allow for a user to determine “the speed drop at t=4.2 s is caused by a curvature-induced comfort constraint, not an obstacle.” In some embodiments, auxiliary plot 152 may serve as a secondary plot for, as non-limiting examples, speed and acceleration. In some embodiments, auxiliary plot 152 may include space vs. other properties. Other properties, in this instance, may include, as non-limiting examples, speed, acceleration, speed limit, steering wheel angle, or another auxiliary parameter.

With continued reference to FIG. 2, memory 112 may include instructions configuring processor 108 to plot a vehicle constraint 212 on spatial axis 132 and temporal axis 136. Constraints may include, as a non-limiting example, obstacles considered by a speed planning algorithm. As non-limiting examples, these obstacles may include vehicles, pedestrians, cyclists, stop lines, and/or yield zones. These obstacles may be projected into the space-time domain and shown on primary plot 140 and/or auxiliary plot 152. In some embodiments, an obstacles future occupancy along vehicle 120 spatial trajectory 116 may be represented as a region or surface in the plot (see, e.g., one or more constraints 212 in FIG. 2.) In some embodiments, dynamic obstacles may include time varying envelopes (as a non-limiting example, note how the region of 212 in FIG. 2 changes as it moves down the spatial axis 132. In some embodiments, static obstacles may produce vertical lines on primary plot 140 and/or auxiliary plot 152.

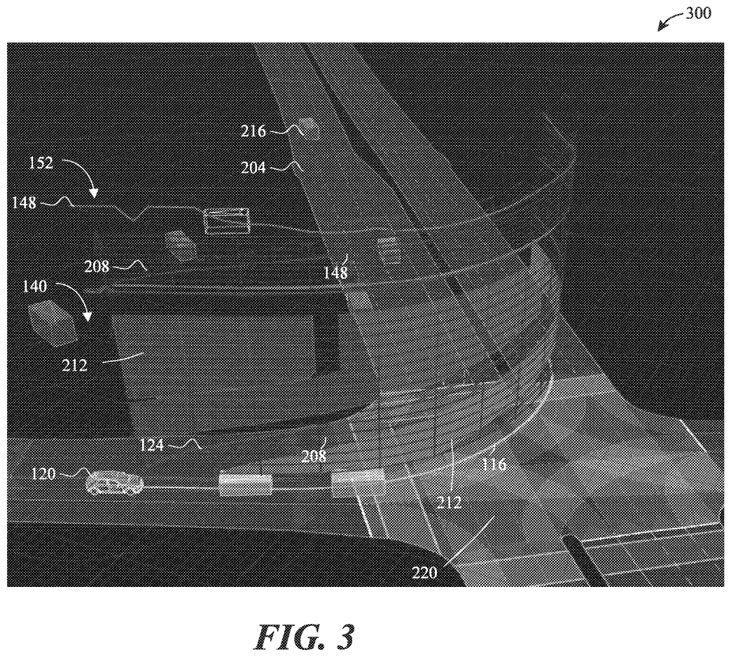

With continued reference to FIGS. 2, 3D visualization 200 may include metadata. For example, metadata may be imported from the according world entity. In some embodiments, each obstacle in the space-time domain may be linked to its originating world entity. In this manner, metadata for the obstacle may be imported. Metadata may include, as non-limiting examples, object ID, object type (vehicle, pedestrian, etc.),. predicted trajectory, and/or confidence and intent metadata. In some embodiments, clicking on, selecting, or otherwise interfacing with an obstacle or its plotted representation through user interface 156 may cause the metadata corresponding with that obstacle to be displayed through user interface 156.

With continued reference to FIG. 2, a 2D map may be displayed in the background. This may provide context for vehicle 120 spatial trajectory 116 and the parameters plotted on primary plot 140 and auxiliary plot 152.

With continued reference to FIG. 2, in some embodiments, 3D visualization 200 may include one or more other vehicles 216. Other vehicles 216 may include, in some embodiments, all vehicles other than vehicle 120. In some embodiments, other vehicles 216 may include vehicles that are not controlled by the autonomous driving system. In 3D visualization 200, other vehicles 216 may be shown using any arbitrary shape, such as a rectangle. In some embodiments, shapes chosen to represent other vehicles 216 may be chosen to be a rudimentary shape so as to minimize the graphical and/or processing power needed to generate 3D visualization 200.

With continued reference to FIG. 2, in some embodiments, 3D visualization 200 may include one or more shaded regions 220 on the ground and/or map. One or more shaded regions 220 may signify regions of the ground and/or map that have an effect on vehicle 120 when vehicle 120 enters them. As non-limiting examples, one or more shaded regions 220 may represent intersections, stop lines, pedestrian blind zones, merge zones, or trajectories for other autonomous vehicles.

Referring now to FIG. 3, another exemplary embodiment of a 3D visualization 300 is shown. 3D visualization 300 may be consistent in some respects with 3D visualization 200 described with reference to FIG. 2. In some embodiments, 3D visualization 300 may include, as non-limiting examples, vehicle 120, spatial trajectory 116, speed profile 124, primary plot 140, auxiliary plot 152, auxiliary parameter 148, road 204, one or more feasibility bounds 208, one or more constraints 212, other vehicles 216, and/or one or more shaded regions 220. Vehicle 120, spatial trajectory 116, speed profile 124, primary plot 140, auxiliary plot 152, auxiliary parameter 148, road 204, one or more feasibility bounds 208, one or more constraints 212, other vehicles 216, and/or one or more shaded regions 220 may be described further with respect to FIGS. 1 and 2.

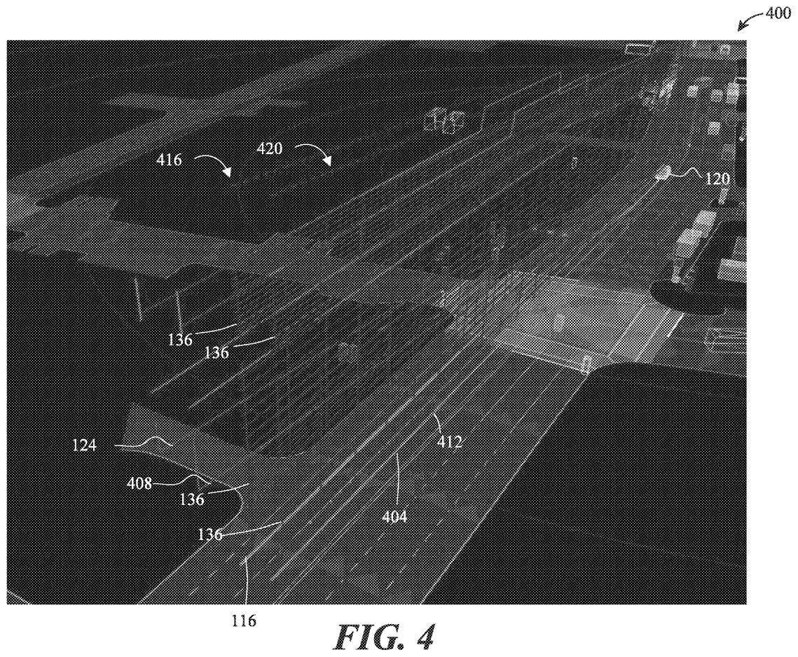

Referring now to FIG. 4, an exemplary multi-trajectory 3D visualization 400 is shown. In some embodiments, multi-trajectory 3D visualization 400 may include a dual-trajectory visualization. In some embodiments, multi-trajectory 3D visualization 400 may include a three trajectory visualization. In some embodiments, multi-trajectory 3D visualization 400 may include a 3+ trajectory visualization. Referring to both FIG. 4 and FIG. 1, memory 112 may include instructions configuring processor 108 to receive a second spatial trajectory 404 for vehicle 120. Memory 112 may include instructions configuring processor 108 to receive a second speed profile 408 for vehicle 120. In some embodiments, generating primary plot 140 may include defining a second spatial axis 412 along an arc length along second spatial trajectory 404. Memory 112 may include instructions configuring processor 108 to plot second speed profile 408 on the second spatial axis 412 and the temporal axis. In a similar manner as has already been described with reference to FIGS. 1 and 2, a user interface 156 may be additionally, plotted for second spatial trajectory 404.

With continued reference to both FIG. 4 and FIG. 1, multi-trajectory 3D visualization 400 may include a first set of plots 416 and a second set of plots 420. First set of plots 416 may include a primary plot 140 and/or auxiliary plot 152 associated with spatial trajectory 116, whereas second set of plots 420 may include a primary plot 140 and/or auxiliary plot 152 associated with second spatial trajectory 404. In this manner, speeds, constraints, obstacles, and/or parameters for both spatial trajectory 116 and second spatial trajectory 404 may be viewed and analyzed by a user at the same time. This may allow users to compare first set of plots 416 and second set of plots 420 to see how they are similar or differ to aid in the diagnosis of problems or explanation of inventions. This presents a clear improvement to the prior art and an improvement in the space of graphical user interfaces and displays. Spatial trajectory 116 and second spatial trajectory 404 may include, as a non-limiting example, different candidate trajectories for 120/. These may include, as non-limiting examples, lane keeping, lane change (left/right), alternative turn radii, and/or fallback or safety trajectories. In some embodiments, each trajectory of spatial trajectory 116 and second spatial trajectory 404 may have its own special axis, obstacle projections, and/or feasible speed envelopes, as non-limiting examples, this may allow users to do side-by-side comparisons of speed feasibility, constrain tightness, and/or risk tradeoffs, as non-limiting examples. A person of ordinary skill in the art, after having read the entirety of this disclosure, would appreciate that this concept could be extended to even more trajectory analyses (e.g., three trajectories, four trajectories, or more).

Referring back to FIG. 1, memory 112 may include instructions configuring processor 108 to display 3D visualization 128 to a user through display device 160. As used in the current disclosure, a “display device” is a device that is used to display content. A display device 160 may include a user interface 156. A “user interface 156,” as used herein, is a means by which a user and a computer system interact; for example, through the use of input devices and software. A user interface 156 may include a graphical user interface 156 (GUI), command line interface (CLI), menu-driven user interface 156, touch user interface 156, voice user interface 156 (VUI), form-based user interface 156, any combination thereof, and the like. A user interface 156 may include a smartphone, smart tablet, desktop, or laptop operated by the user. In an embodiment, the user interface 156 may include a graphical user interface 156. A “graphical user interface (GUI),” as used herein, is a graphical form of user interface 156 that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface 156. For example, links to decentralized platforms as described in this disclosure may be incorporated using icons. Using an icon may be a fast way to open documents, run programs etc. because clicking on them yields instant access. Information contained in user interface 156 may be directly influenced using graphical control elements such as widgets. A “widget,” as used herein, is a user control element that allows a user to control and change the appearance of elements in the user interface 156. In this context a widget may refer to a generic GUI element such as a check box, button, or scroll bar to an instance of that element, or to a customized collection of such elements used for a specific function or application (such as a dialog box for users to customize their computer screen appearances). User interface 156 controls may include software components that a user interacts with through direct manipulation to read or edit information displayed through user interface 156. Widgets may be used to display lists of related items, navigate the system using links, tabs, and manipulate data using check boxes, radial boxes, and the like.

With continued reference to FIG. 1, display device 160 may be used to display the three-dimensional rendered space. For example, this may include, through user interface 156, providing an interactable 3D rendered space. As a non-limiting example, users may be able to use various interface devices such as mice or keyboards to pan and zoom interactable 3D rendered space. Interactable 3D rendered space may include 3D visualization 128. In some embodiments, displaying the 3D rendered space through display device 160 may include displaying primary plot 140 vertically on top of the spatial trajectory 116 for the autonomous vehicle. In some embodiments, displaying the 3D rendered space through display device 160 may include displaying the auxiliary plot 152 vertically on top of the primary plot 140.

With continued reference to FIG. 1, user interface 156 may include one or more filter elements. For the purposes of this disclosure, a “filter element” is a user interface element that allows a user to select data to filter out of or include in a display. For example, filter element may allow a user to select auxiliary parameter 148, constraints, trajectories, or obstacles that the user wishes to see (or not see) in 3D visualization 128. Filter element may include, for example, checkboxes, drop down menus, lists, or the like. Memory 112 may include instructions configuring processor 108 to receive, through user interface 156, a filter selection 164, wherein filter selection 164 comprises a selection to hide one or more of the at least one auxiliary parameter 148. Filter selection 164 may be received through filter element. Memory 112 may include instructions configuring processor 108 to update three-dimensional visualization 128 as a function of filter selection 164 to hide the one or more of the at least one auxiliary parameter 148.

In some embodiments, user interface 156 may support and show interactive linking as described further with respect to FIG. 2. As described with respect to FIG. 2, metadata for objects and obstacles may be imported into 3D visualization 128. In some embodiments, a user hovering over a space-time collision region may cause the user interface 156 to highlight the corresponding 3D bounding box of the obstacle in the world view. For example, if a collision region associated with another car is hovered over or otherwise elected, a view, such as 3d visualization 200 or 3d visualization 300 may be updated to place a bounding box around the other car. In some embodiments, selecting an obstacle in a 3D visualization may cause the space-time footprint of the obstacle to be highlighted. In some embodiments, groups of related entities (e.g., a vehicle and its trailer, or a pedestrian group) can be highlighted together. This bi-directional linkage provides improvements to the existing technology by providing traceability, which is critical for safety analysis and explainability.

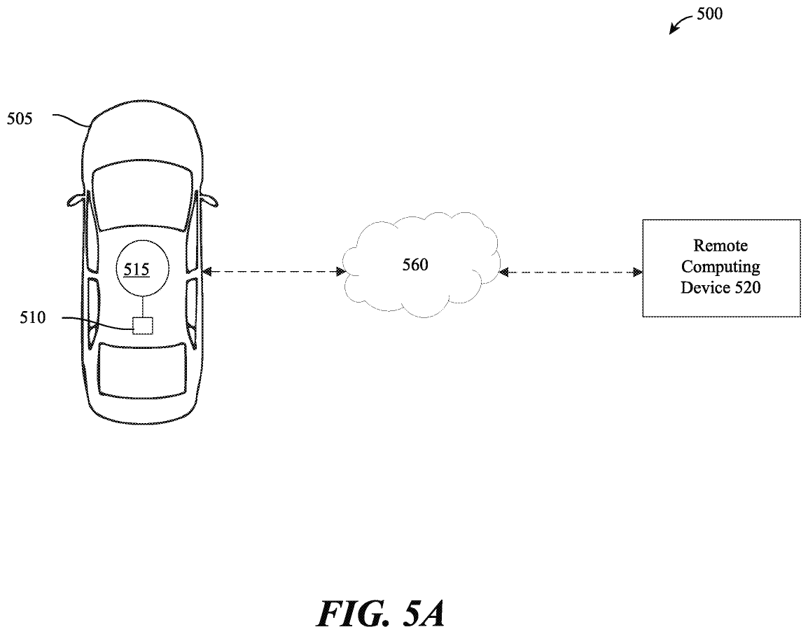

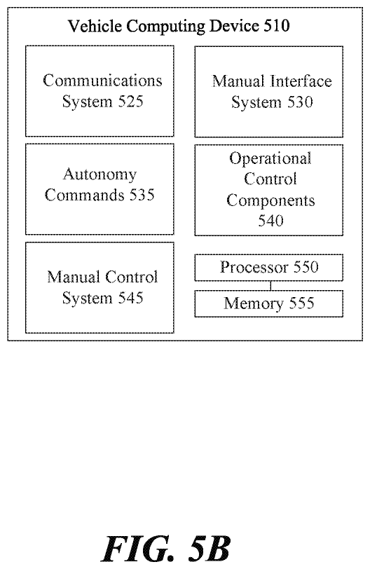

Referring now to FIGS. 5A and 5B, an exemplary vehicle computing architecture 500 is shown. Vehicle computing architecture 500 may include a vehicle 505. A “vehicle,” for the purposes of this disclosure is a device that is designed to transport goods, people, and/or animals. In some embodiments, vehicle 505 may be motorized. As non-limiting examples, vehicle 505 may include a car, a scooter, an ebike, an ATV, a motorcycle, a motorbike, a minibike, a truck, a golf cart, an aircraft, and the like. In some embodiments, vehicle 505 may be human powered. As non-limiting examples, vehicle 505 may include a bike, a rickshaw, a skateboard, a scooter, or the like.

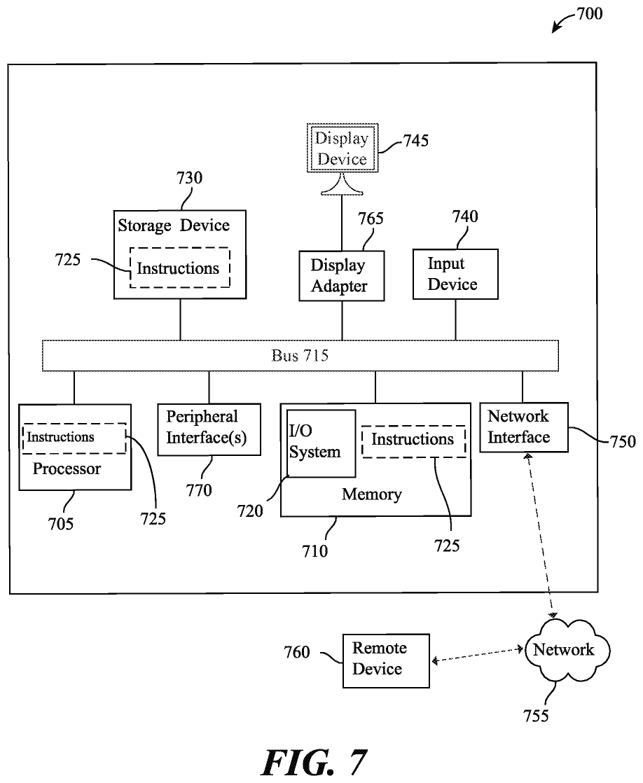

With continued reference to FIGS. 5A AND 5B, the vehicle 505 may be an autonomous vehicle that may drive, navigate, operate, etc. with minimal and/or no interaction from a human driver. Vehicle 505 may include a vehicle computing device 510 that implements a variety of systems on-board the vehicle 505. In some embodiments, vehicle computing device 510 may be consistent with aspects of computing device 700 described further with respect to FIG. 7.

With continued reference to FIGS. 5A and 5B, in some embodiments, vehicle computing architecture 500 may include one or more data acquisition systems 515. A data acquisition system 515 may include a plurality of sensors configured to detect data from the environment surrounding or inside of vehicle 505. In some embodiments, data acquisition system 515 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 515 may include one or more LIDAR sensors. In some embodiments, data acquisition system 515 may include one or more ultrasound sensors. For example, ultrasound sensors may be mounted around the perimeter of vehicle 505. In some embodiments, ultrasound sensors may be located on the corners of vehicle 505. In some embodiments, ultrasound sensors may be used for object detection and/or collision avoidance. In some embodiments, data acquisition system 515 may include one or more microphones. In some embodiments, microphones may be arranged in an array. In some embodiments, microphones may include directional microphones. In some embodiments, microphones may include unidirectional microphones. In some embodiments data acquisition system 515 may include one or more RADAR sensors. In some embodiments, data acquisition system 515 may include, as non-limiting examples, lane detectors, optical readers, electric eyes, and/or other suitable types of image capture devices.

With continued reference to FIGS. 5A and 5B, vehicle computing device 510 may include a plurality of vehicle computing devices 510. As a non-limiting example, in some embodiments, vehicle computing device 510 may include, a central computing device and one or more auxiliary computing devices. In some embodiments, auxiliary computing devices may be located on or in the vehicle 505 roof. In some embodiments, auxiliary computing devices may be located close to certain sensors of data acquisition system 515 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 5A and 5B, the vehicle 505 may be configured to enter into a ready state. The ready state may indicate that the vehicle 505 is ready to operate (and/or return to) an autonomous navigation mode. A computing device on-board the vehicle 505 may be configured to determine whether the vehicle 505 is in the ready state. A remote computing device 520 (e.g., associated with an operations control center) may indicate that the vehicle 505 is ready to begin and/or resume autonomous navigation.

With continued reference to FIGS. 5A and 5B, for instance, the vehicle computing system 510 may include a communications system 525, one or more manual interface systems 530, one or more data acquisition systems 515, an autonomy command 535, one or more operational control components 540, and/or a manual control system 545.

With continued reference to FIGS. 5A and 5B, the manual interface systems 530 may be configured to allow interaction between a user (e.g., human) and the vehicle 505 (e.g., the vehicle computing system 510). The manual interface systems 530 may include a variety of interfaces for the user to input and/or receive information from the vehicle computing system 510. The manual interface systems 530 may include one or more input device(s) (e.g., touchscreens, keypad, touchpad, knobs, buttons, sliders, switches, mouse, gyroscope, microphone, other hardware interfaces) configured to receive user input. The manual interface systems 530 may include a user interface (e.g., graphical user interface, conversational and/or voice interfaces, chatter robot, gesture interface, other interface types) for receiving user input.

With continued reference to FIGS. 5A and 5B, vehicle computing system 510 may include a processor 550 and a memory 555. Processor 550 and memory 555 may be consistent with other processors and memory described throughout this disclosure. Processor 550 and memory 555 may be communicatively connected. Memory 555 may contain instructions (e.g., software) configured to cause processor 550 to perform one or more actions in accordance with this disclosure.

With continued reference to FIGS. 5A and 5B, vehicle computing architecture 500 may include a remote computing device 520. the remote computing device 520 may include and/or otherwise be associated with one or more computing devices (e.g., computing device 700 referred to in FIG. 7 that are remote from the vehicle 505. The remote computing device 520 may communicate with the vehicle 505 via one or more communications networks 560. The communications network 560 may include various wired and/or wireless communication mechanisms (e.g., cellular, wireless, satellite, microwave, and radio frequency) and/or any desired network topology. For example, the communications network 560 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 505.

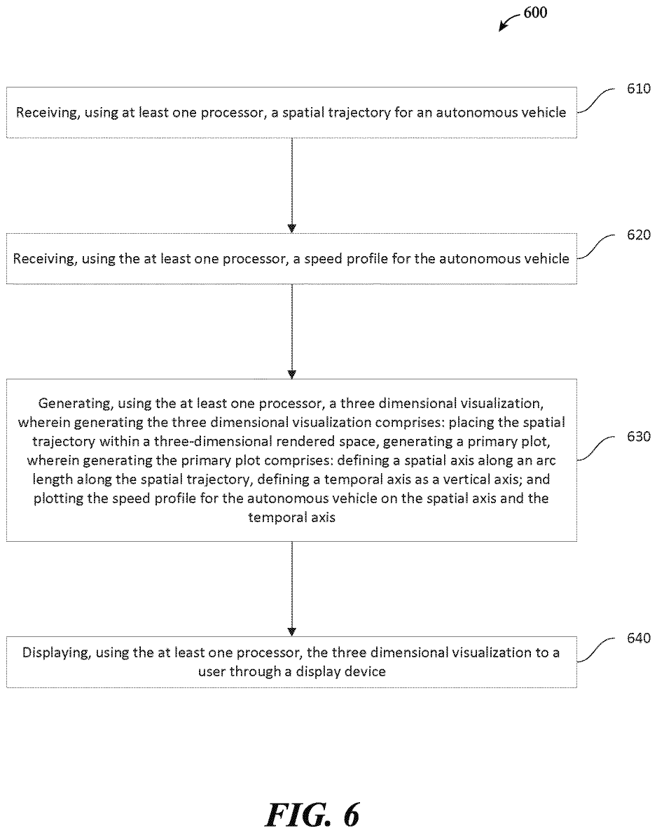

Referring now to FIG. 6, a method 600 for three-dimensional plot visualization is shown. Method 600 includes a step 610 of receiving, using at least one processor, a spatial trajectory for an autonomous vehicle. This may be conducted as described, without limitation, with respect to FIGS. 1-5B.

Referring now to FIG. 6, method 600 includes a step 620 of receiving, using the at least one processor, a speed profile for the autonomous vehicle. This may be conducted as described, without limitation, with respect to FIGS. 1-5B.

Referring now to FIG. 6, method 600 includes a step 630 of generating, using the at least one processor, a three dimensional visualization, wherein generating the three dimensional visualization includes: placing the spatial trajectory within a three-dimensional rendered space; generating a primary plot, wherein generating the primary plot includes: defining a spatial axis along an arc length along the spatial trajectory; defining a temporal axis as a vertical axis; and plotting the speed profile for the autonomous vehicle on the spatial axis and the temporal axis. This may be conducted as described, without limitation, with respect to FIGS. 1-5B.

Referring now to FIG. 6, method 600 includes a step 640 of displaying, using the at least one processor, the three dimensional visualization to a user through a display device. This may be conducted as described, without limitation, with respect to FIGS. 1-5B.

In some aspects, the techniques described herein relate to a method, wherein the spatial axis is configured to follow one or more curvatures of the spatial trajectory. This may be conducted as described, without limitation, with respect to FIGS. 1-5B.

In some aspects, the techniques described herein relate to a method, wherein generating the three dimensional visualization further includes generating an auxiliary plot, wherein generating the auxiliary plot includes: defining a secondary spatial axis along the arc length along the spatial trajectory; plotting the at least one auxiliary parameter on the secondary spatial axis and the temporal axis. This may be conducted as described, without limitation, with respect to FIGS. 1-5B.

In some aspects, the techniques described herein relate to a method, wherein the at least one auxiliary parameter is selected from a list consisting of vehicle speed, longitudinal acceleration, jerk, path curvature, speed limits, and acceleration. This may be conducted as described, without limitation, with respect to FIGS. 1-5B.

In some aspects, the techniques described herein relate to a method, further including: receiving, using the at least one processor and through a user interface, a filter selection, wherein the filter selection includes a selection to hide one or more of the at least one auxiliary parameter; and updating, using the at least one processor, the three dimensional visualization as a function of the filter selection to hid the one or more of the at least one auxiliary parameter. This may be conducted as described, without limitation, with respect to FIGS. 1-5B.

In some aspects, the techniques described herein relate to a method, wherein displaying the three dimensional visualization to the user through the display device includes: displaying the three-dimensional rendered space; displaying the primary plot vertically on top of the spatial trajectory for the autonomous vehicle; and displaying the auxiliary plot vertically on top of the primary plot. This may be conducted as described, without limitation, with respect to FIGS. 1-5B.

In some aspects, the techniques described herein relate to a method, wherein displaying the three-dimensional visualization to the user through the display device includes: displaying the three-dimensional rendered space; and displaying the primary plot vertically on top of the spatial trajectory for the autonomous vehicle. This may be conducted as described, without limitation, with respect to FIGS. 1-5B.

In some aspects, the techniques described herein relate to a method, further including receiving, using the at least one processor, the spatial trajectory for the autonomous vehicle and the speed profile for the autonomous vehicle from an autonomous vehicle data database. This may be conducted as described, without limitation, with respect to FIGS. 1-5B.

In some aspects, the techniques described herein relate to a method, wherein: the method further includes: receiving, using the at least one processor, a second spatial trajectory for an autonomous vehicle; and receiving, using the at least one processor, a second speed profile for the autonomous vehicle; and generating the primary plot further includes: defining a second spatial axis along an arc length along the second spatial trajectory; and plotting the second speed profile on the second spatial axis and the temporal axis. This may be conducted as described, without limitation, with respect to FIGS. 1-5B.

In some aspects, the techniques described herein relate to a method, wherein generating the primary plot further includes plotting a vehicle constraint on the spatial axis and the temporal axis. This may be conducted as described, without limitation, with respect to FIGS. 1-5B.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 705 and a memory 710 that communicate with each other, and with other components, via a bus 715. Bus 715 may include any of several types of bus structures including, but not limited to, a memory bus, a memory controller, a peripheral bus, a local bus, and any combinations thereof, using any of a variety of bus architectures.

Processor 705 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 705 may be organized according to Von Neumann and/or Harvard architecture as a non-limiting example. Processor 705 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 710 may include various components (e.g., machine-readable media) including, but not limited to, a random-access memory component, a read only component, and any combinations thereof. In one example, a basic input/output system 720 (BIOS), including basic routines that help to transfer information between elements within computer system 700, such as during start-up, may be stored in memory 710. Memory 710 may also include (e.g., stored on one or more machine-readable media) instructions (e.g., software) 725 embodying any one or more of the aspects and/or methodologies of the present disclosure. In another example, memory 710 may further include any number of program modules including, but not limited to, an operating system, one or more application programs, other program modules, program data, and any combinations thereof. Memory 710 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 700 may also include a storage device 730. Examples of a storage device (e.g., storage device 730) include, but are not limited to, a hard disk drive, a magnetic disk drive, an optical disc drive in combination with an optical medium, a solid-state memory device, and any combinations thereof. Storage device 730 may be connected to bus 715 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 730 (or one or more components thereof) may be removably interfaced with computer system 700 (e.g., via an external port connector (not shown)). Particularly, storage device 730 and an associated machine-readable medium may provide nonvolatile and/or volatile storage of machine-readable instructions, data structures, program modules, and/or other data for computer system 700. In some embodiments, storage device 730 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 725) may reside, completely or partially, within machine-readable medium. In another example, software may reside, completely or partially, within processor 705.

Computer system 700 may also include an input device 740. In one example, a user of computer system 700 may enter commands and/or other information into computer system 700 via input device 740. Examples of an input device 740 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 740 may be interfaced to bus 715 via any of a variety of interfaces (not shown) including, but not limited to, a serial interface, a parallel interface, a game port, a USB interface, a FIREWIRE interface, a direct interface to bus 715, and any combinations thereof. Input device 740 may include a touch screen interface that may be a part of or separate from display 745, discussed further below. Input device 740 may be utilized as a user selection device for selecting one or more graphical representations in a graphical interface as described above.

A user may also input commands and/or other information to computer system 700 via storage device 730 (e.g., a removable disk drive, a flash drive, etc.) and/or network interface device 750. A network interface device, such as network interface device 750, may be utilized for connecting computer system 700 to one or more of a variety of networks, such as network 755, and one or more remote devices 760 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 755, may employ a wired and/or a wireless mode of communication. In general, any network topology may be used. Information (e.g., data, software, etc.) may be communicated to and/or from computer system 700 via network interface device 750.

Computer system 700 may further include a video display adapter 765 for communicating a displayable image to a display device, such as display 745. Examples of a display device include, but are not limited to, a liquid crystal display (LCD), a cathode ray tube (CRT), a plasma display, a light emitting diode (LED) display, and any combinations thereof. Display adapter 765 and display 745 may be utilized in combination with processor 705 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 715 via a peripheral interface 770. Examples of a peripheral interface include, but are not limited to, a serial port, a USB connection, a FIREWIRE connection, a parallel connection, and any combinations thereof.

Further referring to FIG. 7, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 7, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 7, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 700, processor 705, and memory 710 may be virtualized; that is, a virtual machine and/or container may interact directly with such computing system 700, processor 705, and/or memory 710, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 705 comprises a plurality of processors and/or processor cores, virtualization may, in some cases, simulate or emulate a single (virtual) processor whose functions are allocated to one or more of the plurality of processors and/or processor cores. In this case, while processor 705 may be said to be virtualized, the processor 705, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular systems and methods used to implement the disclosure may be modified without changing the spirit of the disclosure, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for three-dimensional plot visualization, the system comprising:
at least one processor; and
a memory communicatively connected to the at least one processor, wherein the memory contains instructions configuring the at least one processor to:
receive a spatial trajectory for an autonomous vehicle;
receive a speed profile for the autonomous vehicle;
generate a three-dimensional visualization, wherein generating the three-dimensional visualization comprises:
placing the spatial trajectory within a three-dimensional rendered space;
generating a primary plot, wherein generating the primary plot comprises:
defining a spatial axis along an arc length along the spatial trajectory;
defining a temporal axis as a vertical axis; and
plotting the speed profile for the autonomous vehicle on the spatial axis and the temporal axis; and
displaying the three-dimensional visualization to a user through a display device.

2. The system of claim 1, wherein the spatial axis is configured to follow one or more curvatures of the spatial trajectory.

3. The system of claim 1, wherein generating the three-dimensional visualization further comprises generating an auxiliary plot, wherein generating the auxiliary plot comprises:
defining a secondary spatial axis along the arc length along the spatial trajectory;
plotting at least one auxiliary parameter on the secondary spatial axis and the temporal axis.

4. The system of claim 3, wherein the at least one auxiliary parameter is selected from the list consisting of vehicle speed, longitudinal acceleration, jerk, path curvature, speed limits, lateral acceleration, steering wheel angle, and steering wheel rotation rate.

5. The system of claim 3, wherein the memory contains instructions further configuring the at least one processor to:
receive, through a user interface, a filter selection, wherein the filter selection comprises a selection to hide one or more of the at least one auxiliary parameter; and
update the three-dimensional visualization as a function of the filter selection to hide the one or more of the at least one auxiliary parameter.

6. The system of claim 3, wherein displaying the three-dimensional visualization to the user through the display device comprises:
displaying the three-dimensional rendered space;
displaying the primary plot vertically on top of the spatial trajectory for the autonomous vehicle; and
displaying the auxiliary plot vertically on top of the primary plot.

7. The system of claim 1, wherein displaying the three-dimensional visualization to the user through the display device comprises:
displaying the three-dimensional rendered space; and
displaying the primary plot vertically on top of the spatial trajectory for the autonomous vehicle.

8. The system of claim 1, wherein the spatial trajectory for the autonomous vehicle and the speed profile for the autonomous vehicle are received from an autonomous vehicle data database.

9. The system of claim 1, wherein:
the memory contains instructions further configuring the at least one processor to:
receive a second spatial trajectory for an autonomous vehicle; and
receive a second speed profile for the autonomous vehicle; and
generating the primary plot further comprises:
defining a second spatial axis along an arc length along the second spatial trajectory; and
plotting the second speed profile on the second spatial axis and the temporal axis.

10. The system of claim 1, wherein generating the primary plot further comprises plotting a vehicle constraint on the spatial axis and the temporal axis.

11. A method for three-dimensional plot visualization, the method comprising:
receiving, using at least one processor, a spatial trajectory for an autonomous vehicle;
receiving, using the at least one processor, a speed profile for the autonomous vehicle;
generating, using the at least one processor, a three-dimensional visualization, wherein generating the three-dimensional visualization comprises:
placing the spatial trajectory within a three-dimensional rendered space;
generating a primary plot, wherein generating the primary plot comprises:
defining a spatial axis along an arc length along the spatial trajectory;
defining a temporal axis as a vertical axis; and
plotting the speed profile for the autonomous vehicle on the spatial axis and the temporal axis; and
displaying, using the at least one processor, the three-dimensional visualization to a user through a display device.

12. The method of claim 11, wherein the spatial axis is configured to follow one or more curvatures of the spatial trajectory.

13. The method of claim 11, wherein generating the three-dimensional visualization further comprises generating an auxiliary plot, wherein generating the auxiliary plot comprises:
defining a secondary spatial axis along the arc length along the spatial trajectory;
plotting at least one auxiliary parameter on the secondary spatial axis and the temporal axis.

14. The method of claim 13, wherein the at least one auxiliary parameter is selected from the list consisting of vehicle speed, longitudinal acceleration, jerk, path curvature, speed limits, lateral acceleration, steering wheel angle, and steering wheel rotation rate.

15. The method of claim 13, further comprising:
receiving, using the at least one processor and through a user interface, a filter selection, wherein the filter selection comprises a selection to hide one or more of the at least one auxiliary parameter; and
updating, using the at least one processor, the three-dimensional visualization as a function of the filter selection to hide the one or more of the at least one auxiliary parameter.

16. The method of claim 13, wherein displaying the three-dimensional visualization to the user through the display device comprises:
displaying the three-dimensional rendered space;
displaying the primary plot vertically on top of the spatial trajectory for the autonomous vehicle; and
displaying the auxiliary plot vertically on top of the primary plot.

17. The method of claim 11, wherein displaying the three-dimensional visualization to the user through the display device comprises:
displaying the three-dimensional rendered space; and
displaying the primary plot vertically on top of the spatial trajectory for the autonomous vehicle.

18. The method of claim 11, further comprising receiving, using the at least one processor, the spatial trajectory for the autonomous vehicle and the speed profile for the autonomous vehicle from an autonomous vehicle data database.

19. The method of claim 11, wherein:
the method further comprises:
receiving, using the at least one processor, a second spatial trajectory for an autonomous vehicle; and
receiving, using the at least one processor, a second speed profile for the autonomous vehicle; and
generating the primary plot further comprises:
defining a second spatial axis along an arc length along the second spatial trajectory; and
plotting the second speed profile on the second spatial axis and the temporal axis.

20. The method of claim 11, wherein generating the primary plot further comprises plotting a vehicle constraint on the spatial axis and the temporal axis.
